(19) United States
(12) Patent Application Publication
(10) Pub. No.: US 2003/0009249 A1
(43) Pub. Date: Jan. 9, 2003

(54) Audio jack module with integrated audio interface functionality

(76) Inventors: Frederick Loeb, Scituate, MA (US); David Babicz, Medway, MA (US)

Correspondence Address: Iandiorio & Teska, 260 Bear Hill Road, Waltham, MA, 02451-1018, US

(21) Appl. No.: 10/175,759

(22) Filed: Jun. 20, 2002

Related U.S. Application Data
(60) Provisional application No. 60/299,863, filed on Jun. 21, 2001.

(51) Int. Cl. G06F 17/00

(52) U.S. Cl. 700/94

(57) ABSTRACT

An audio jack module with integrated audio interface functionality including a housing of a predetermined size, at least one analog interface plug assembly on the housing, a number of digital interface system leads extending from the housing, and a circuit board in the housing including an audio coder/decoder circuit and audio support circuitry interconnected between the analog interface plug assembly and the digital interface system leads resulting in a segregated, shielded, low noise audio interface for processor based systems and equipment.

### RELATED APPLICATIONS

This invention claims priority of Provisional Patent Application Serial No. 60/299,863 filed Jun. 21, 2001.

### FIELD OF THE INVENTION

This invention relates to an audio jack module with integrated audio interface functionality in the field of computers and other types of processor based systems and equipment which require analog audio input signals to be converted into digital signals and which require digital audio signals be converted into analog audio output signals.

### BACKGROUND OF THE INVENTION

Certain computers and other processor based systems and equipment include audio jack modules whereby microphones, speakers, and other devices are interconnected with the computer via analog plugs. The motherboard of such a computer including a central processing unit (CPU), memories, and the like will then include a coder/decoder (CODEC) chip such as the AD 1981 chip manufactured by the assignee of this invention. Audio support circuitry is further included on the motherboard of the computer typically surrounding the AD 1981 CODEC chip. An audio jack module sized to fit the input/output panel opening of the system enclosure is electrically connected to the CODEC chip and the audio support circuitry which itself is connected to the central processing unit on the motherboard via a serial bus and a control chip also on the motherboard. This combination, inter alia, converts the analog signals from components (e.g., a microphone) plugged into the jack module to digital signals to be processed by the CPU and also converts the digital signals on the motherboard to analog signals output to components (e.g., speakers) also plugged into the jack module.

The inventors hereof realized that there are numerous problems associated with the integration of the CODEC chip and the related audio support circuitry directly on the motherboard of a computer or other processor based systems and equipment.

First, the space taken up on the motherboard by the CODEC chip and the related audio support circuitry limits the addition of other processing circuitry or other circuit functionality on the motherboard. A related problem is the design constraints concerning the placement of the audio circuitry on the motherboard which, to some extent, limits the design flexibility of the motherboard.

Second, the addition of the CODEC chip and related audio support circuitry to the motherboard can cause noise and interference problems which must be overcome by the motherboard designers and fabricators. Moreover, discovering whether the audio circuitry or the other electronic components of the motherboard or even combinations thereof are causing unwanted noise or interference and then taking the appropriate corrective action can be difficult.

Third, the combination of the motherboard with the audio circuitry thereon must be qualified or certified for compliance with electromagnetic interference and electrostatic discharge standards and requirements. Again, discerning between whether the audio circuitry or the other electronic components on the motherboard are causing a certification failure and then taking the appropriate corrective action can be problematic. On the other hand, it is not feasible to simply move the CODEC chip and the related audio support circuitry off the motherboard and, for example, into the jack module.

For example, the AD 1981 CODEC chip itself is four inches square. Were it moved to the jack module, the size of the jack module housing would have to increase to the point where it could not be received in standard size computer enclosure input/output panel openings.

And, the motherboard often includes an analog mixer and analog interface system connections (for a stereo CD-ROM, for example). Even if the jack module was increased in size to accommodate the CODEC chip, the functionality previously supplied by the analog mixer and the analog interface system connections would be lost.

Finally, the AD 1981 CODEC chip operates at 24.576 MHz. Other components connected to the motherboard (e.g., modems), however, operate at 12.288 MHz. Thus, a large clock oscillator circuit resides on the motherboard of the system to supply the 12.288 MHz clock signal. Were the jack module to include this clock oscillator circuit, again, its size would render the jack module too large and it could not be received in standard size computer enclosure input/output panel openings. Alternatively, if the jack module does not include a 12.288 MHz clock circuit, there would be no support for modems and other subsystems which operate at a frequency different than the CODEC chip.

### SUMMARY OF THE INVENTION

It is therefore an object of this invention to provide a audio jack module with integrated audio interface functionality.

It is a further object of this invention to provide such an integrated audio jack module which frees up additional space on the motherboard of the processor based equipment previously taken up with the audio CODEC chip and the related audio support circuitry.

It is a further object of this invention to provide such an integrated audio jack module which adds design flexibility to the design and configuration of the motherboard of processor based systems and equipment of all types.

It is a further object of this invention to provide such an integrated audio jack module which eliminates any noise or interference problems associated with audio circuitry used in conjunction with processor based equipment.

It is a further object of this invention to provide such an integrated audio jack module which can be pre-qualified or certified for compliance with electromagnetic interference and electrostatic discharge standards and requirements.

It is a further object of this invention to provide such an integrated audio jack module which is the same size as prior art audio jack modules lacking any audio interface functionality and which thus can be received in standard size system enclosure input/output panel openings.

It is a further object of this invention to provide such an integrated audio jack module which fully supports internal system analog connections.

It is a further object of this invention to provide such an integrated audio jack module which includes a clock output pin which supplies a 12.288 MHz clock signal.

This invention results from the realization that a standard size audio jack module can be designed to include audio interface functionality if a small circuit board is included therein and populated with the die of a unique CODEC chip and also audio support circuitry and if the jack module also includes a number of digital interface system leads extending from the jack module interconnected with the CODEC die, the result is a shielded, pre-qualified subsystem which can be easily interfaced with various types of processor based systems and equipment to increase the available real estate on the motherboard of such equipment.

This invention results from the further realization that by adding analog mixer functionality to the CODEC die, analog interface system leads can also be included to support motherboard system analog connections. This invention results from the still further realization that by adding a phase lock loop subcircuit to the CODEC die, the need for a separate large clock oscillator on the circuit board of the jack module is eliminated again ensuring that the size of the jack module remains the same as standard size audio jack modules without audio interface functionality.

This invention features an audio jack module with integrated audio interface functionality comprising a housing of a predetermined size, at least one analog interface plug assembly on the housing, a number of digital interface system leads extending from the housing, and a circuit board in the housing including an audio coder/decoder circuit and audio support circuitry interconnected between the analog interface plug assembly and the digital interface system leads resulting in a segregated, shielded, low noise audio interface.

The housing is preferably made of metal to shield the coder/decoder circuit and the audio support circuitry. Typically, the analog interface plug assembly includes a mechanical plug portion and an electrical contact portion including a number of conductors electrically connected to the circuit board. Usually, there are a plurality of audio interface plug assemblies such as RCA, mini-RCA, 3.5 mm, and/or 2.5 mm plugs. A header inside the housing includes the digital interface system leads and receives the circuit board to electrically connect it to the digital interface system leads.

The size of the housing is preferably the same as the housing of audio jack modules without integrated audio interface functionality and thus the housing of the integrated audio jack module can be received in standard size system enclosure input/output panel openings. The digital interface system leads may be pins and further included may be analog interface system pins interconnected with the coder/decoder circuit to support internal system analog connections.

The coder/decoder circuit may then include an analog mixer connected to the analog interface system leads, the digital interface system leads, and the analog interface plug assembly and an analog-to-digital converter interconnected between the analog interface system leads and the digital interface system leads. There may also be a clock input and then the audio coder/decoder includes a phase lock loop circuit connected to the clock input to convert a clock signal thereon to a different frequency. In one example, the phase lock loop is configured to convert the clock signal from a 14.31818 MHz signal to a 12.288 MHz signal and there is a clock output for transmitting the 12.288 MHz frequency clock signal.

An exemplary audio jack module with integrated audio interface functionality in accordance with this invention features a housing, a plurality of analog interface conductors on the housing, a number of digital interface system conductors exterior of the housing, and a circuit board in the housing including an audio coder/decoder circuit and audio support circuitry interconnected between the analog interface conductors and the digital interface system conductors resulting in a segregated, shielded, low noise audio interface. Typically, the housing has a size the same as standard audio jack modules without integrated audio interface functionality and is thus sized to be received in standard system enclosure input/output panel openings.

Another exemplary audio jack module with integrated audio interface functionality in accordance with this invention features a housing, at least one analog interface plug assembly on the housing, a number of digital interface system leads extending from the housing, a circuit board in the housing including an audio coder/decoder circuit and audio support circuitry interconnected between the analog interface plug assembly and the digital interface system leads, and analog interface system leads interconnected with the coder/decoder circuit to support internal system analog connections. Typically, the coder/decoder circuit includes an analog mixer connected to the analog interface system leads, the digital interface system leads, and the analog interface plug assembly. An analog-to-digital converter is then interconnected between the analog interface system leads and the digital interface system leads.

Still another exemplary audio jack module with integrated audio interface functionality features a housing, at least one analog interface plug assembly on the housing, a number of digital interface system leads extending from the housing, a clock input, and a circuit board in the housing including an audio coder/decoder circuit and audio support circuitry interconnected between the analog interface plug assembly and the digital interface system leads, the coder/decoder including a phase lock loop circuit connected to the clock input to convert a clock signal thereon to a different frequency. Typically, the phase lock loop is configured to convert the clock signal from a 14.31818 MHz signal to a 12.288 MHz signal and there is a clock output lead for transmitting the 12.288 MHz frequency clock signal.

This invention also features an audio jack module with integrated audio interface functionality comprising a housing of a predetermined size, at least one analog interface plug assembly on the housing, a number of digital interface system leads extending from the housing, and means for converting analog signals received by the analog interface plug assembly to digital signals output by the digital interface system leads and for converting digital signals received by the digital interface system leads to analog signals output by the analog interface plug assembly. In one preferred embodiment, the means for converting includes an audio coder/decoder circuit and audio support circuitry interconnected between the analog interface plug assembly and the digital interface system leads.

### BRIEF DESCRIPTION OF THE DRAWINGS

Other objects, features and advantages will occur to those skilled in the art from the following description of a preferred embodiment and the accompanying drawings, in which:

FIG. 1 is a schematic view of a typical prior art system motherboard including audio interface functionality;

FIG. 2 is a schematic view of a prior art audio jack module;

FIG. 3 is a more detailed circuit diagram of the audio interface circuitry on the motherboard of a system in accordance with the prior art;

FIG. 4 is an exploded schematic view of the audio jack module with integrated audio interface functionality in accordance with the subject invention;

FIG. 5 is a side view of the integrated audio jack module of the subject invention;

FIG. 6 is a schematic partially exploded view showing the processing/audio interface system in accordance with the subject invention whereby the integrated audio jack module of the subject invention is in place on the motherboard of a processor based system;

FIG. 7 is a block diagram showing the primary components associated with the circuit board of the integrated audio jack module of this invention;

FIG. 8 is a more detailed circuit diagram of the circuitry on the circuit board inside the integrated audio jack module of the subject invention;

FIG. 9 is a functional block diagram depicting the functionality of the CODEC die on the circuit board inside the integrated audio jack module of the subject invention; and

FIG. 10 is a schematic of the coded integrated audio jack system interface leads for use by motherboard and system designers.

### DISCLOSURE OF THE PREFERRED EMBODIMENT

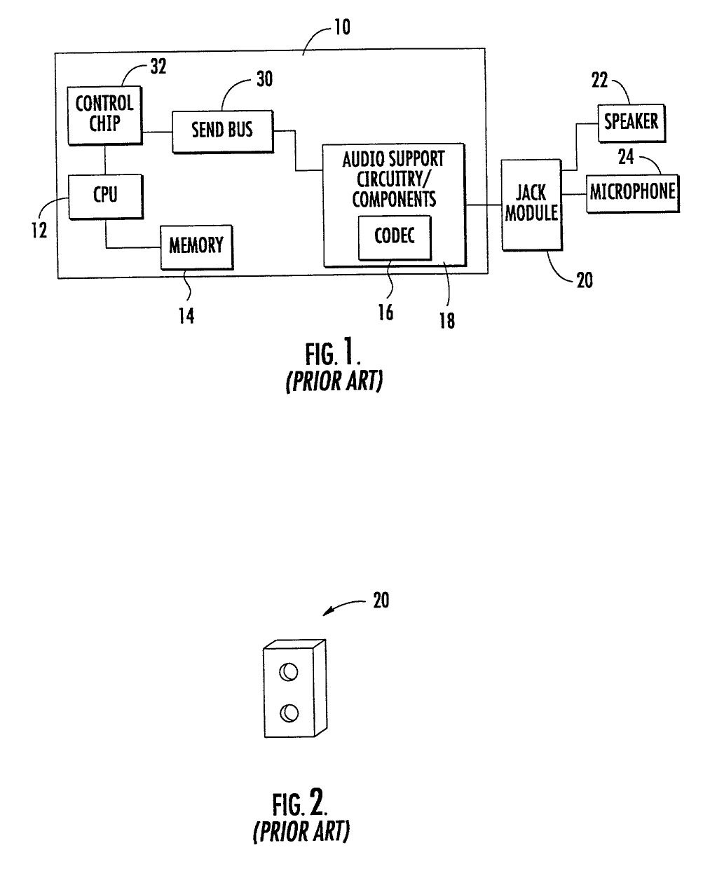

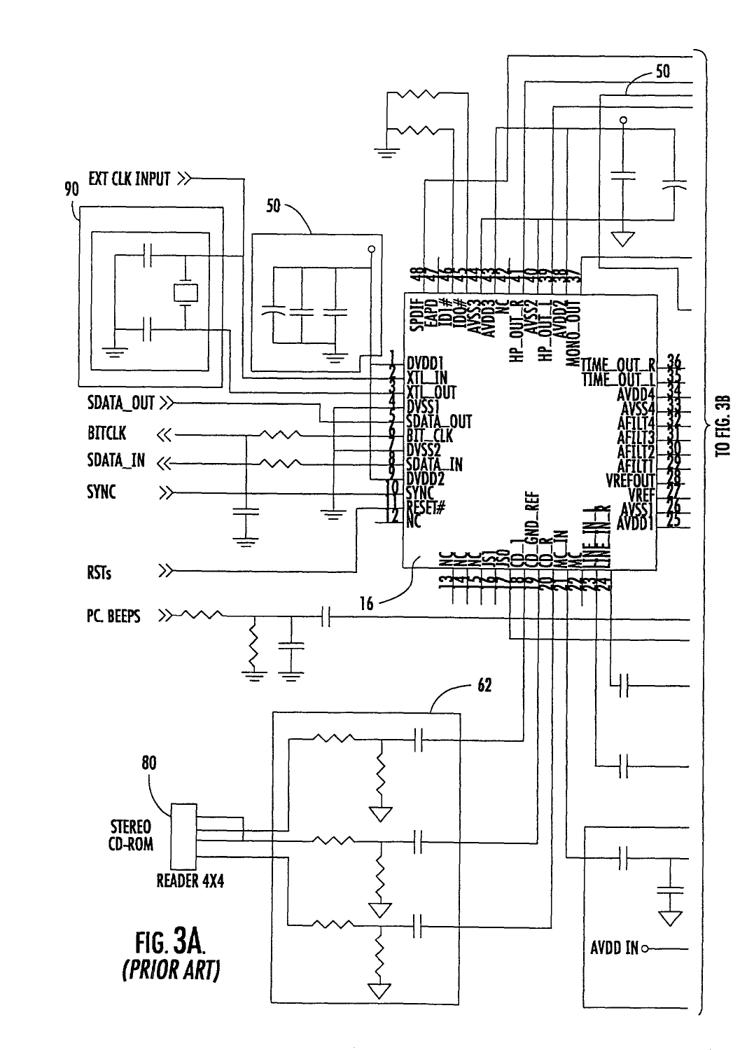

Prior art processor based systems such as computers typically include motherboard 10, FIG. 1 including CPU 12, memory 14 and various other circuitry not explicitly shown but understood by those skilled in the art. For processor based systems with an audio processing functionality, motherboard 10 also includes CODEC 16 and audio support components forming audio support circuit 18 electrically connected to jack module 20, FIGS. 1-2. Speaker 22, FIG. 1, microphone 24, and other analog input and output devices are then electrically connected to jack module 20 via plugs, like RCA plugs, for example.

The combination of CODEC 16 and audio support circuit 18 converts the analog signal output by microphone 22 to digital signals delivered to CPU 12 via serial bus 30 and control chip 32 for processing and also converts the digital signals from components on or connected to motherboard 10 to an analog signal which drives speaker 22. Those skilled in the art will understand that the operation of prior art motherboard 10 and the audio portion thereof and will also understand that FIG. 1 is highly schematic.

As delineated in the Background section above, CODEC chip 16 and audio support circuit 18 take up space on motherboard 10 which could instead be used by circuitry configured to provide other additional functionality to the processor based system.

Moreover, the population of motherboard 10 with CODEC 16 and audio support circuit 18 imparts design constraints concerning the proper placement of CODEC 16, audio support circuit 18, and the other components on motherboard 10 resulting in design inflexibility.

The addition of CODEC chip 16 and audio support circuit 18 to motherboard 10 can also cause noise and interference problems which must be overcome by the designer of motherboard 10. And, if noise or interference is detected after the fabrication of motherboard 10, it can be difficult to ascertain whether the noise or interference is caused by CODEC 16, audio support circuit 18, the other circuits and chips on motherboard 10, or combinations of the same.

Motherboard 10 must also be qualified or certified for compliance with electromagnetic interference and electrostatic discharge standards and requirements. Again, if these standards are not met after the fabrication of motherboard 10, it can be difficult to discern whether a failure is caused by CODEC 16, audio support circuit 18, the other electronic components of motherboard 10, or combinations of the same.

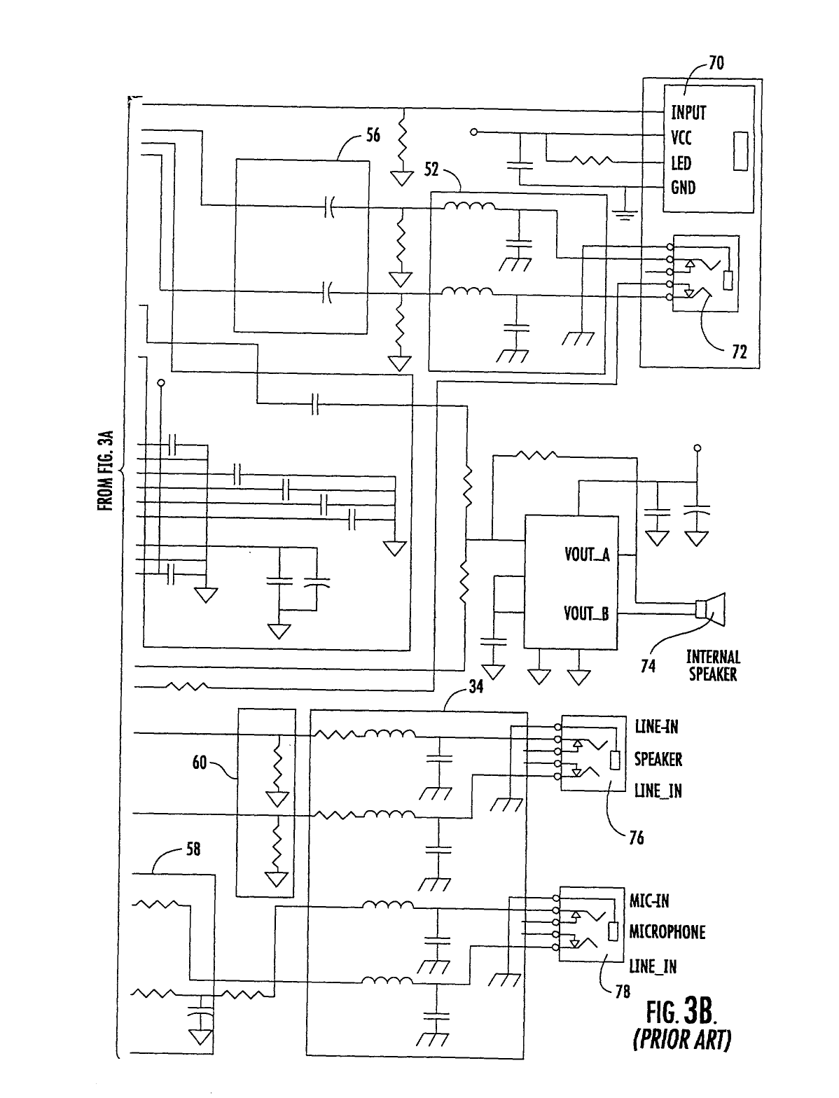

FIG. 3 shows in more detail CODEC 16 and audio support circuit 18 which may include CODEC specific support subcircuits 50, electromagnetic interference subcircuits 52 and 54, headphone sub-circuit 56, microphone sub-circuit 58, input subcircuits 60 and 62, and the other topology shown in FIG. 3 which provides an interface between CODEC 16 and SPDIF jack output 70, microphone input 72, internal speaker 74, speaker line in input 76, microphone line in input 78, and stereo CD-ROM header 80.

As delineated in the Background section above, although it is clearly desirable to move all this circuitry from motherboard 10 and place it instead in jack module 20, FIGS. 1-2, there are several design constraints associated with such a reconfiguration.

First, CODEC chip 16 itself is four inches square and its placement on a circuit board added to jack module 20, FIGS. 1-2 would increase the size of jack module 20 to the point where it could not be received in the computer enclosure input/output panel opening.

Second, motherboard 10 typically includes an analog mixer and analog interface system interconnects (for CD-ROM 80, FIG. 3, for example). Were the circuitry of FIG. 3 simply moved to jack module 20, FIGS. 1-2, the functionality previously supplied by the analog mixer and the analog interface system interconnections would be lost.

Finally, clock oscillator circuit 90, FIG. 3 must be included on motherboard 10, FIG. 1 to support 12.288 MHz clock frequencies for some components such as modems. Were jack module 20, FIGS. 1-2 to include clock oscillator circuit 90, FIG. 3 its size would render the jack module too large and it could not be received in standard size computer enclosure input/output panel openings. If clock oscillator circuit 90, FIG. 3 is left out of the resulting circuitry, there would be no support for modems and other components which operate at 12.288 MHz or any other frequency different than the frequency which drives the CODEC.

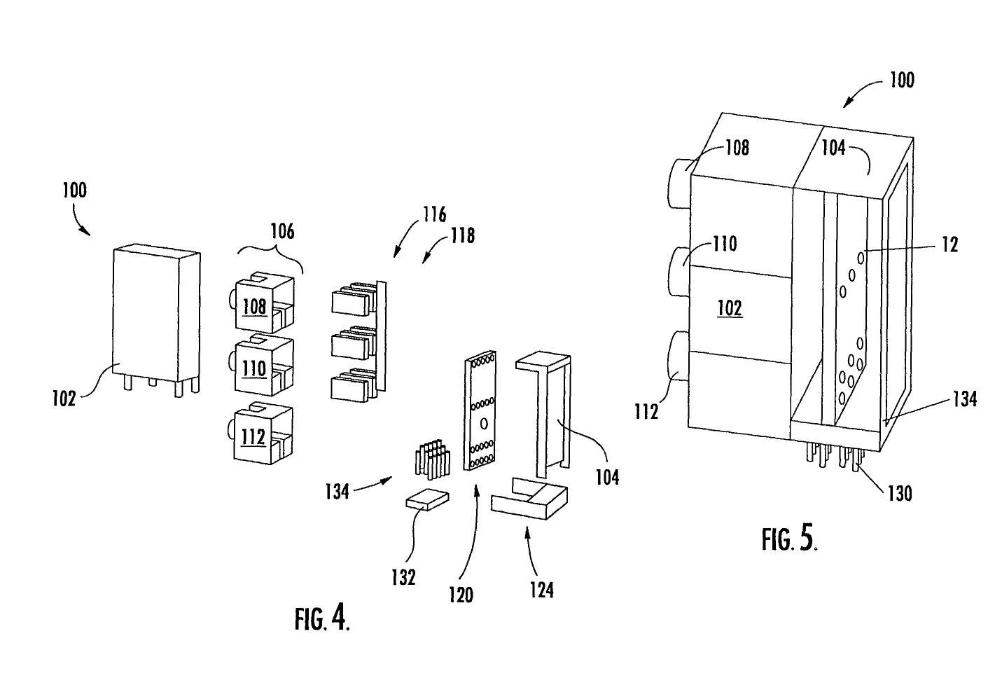

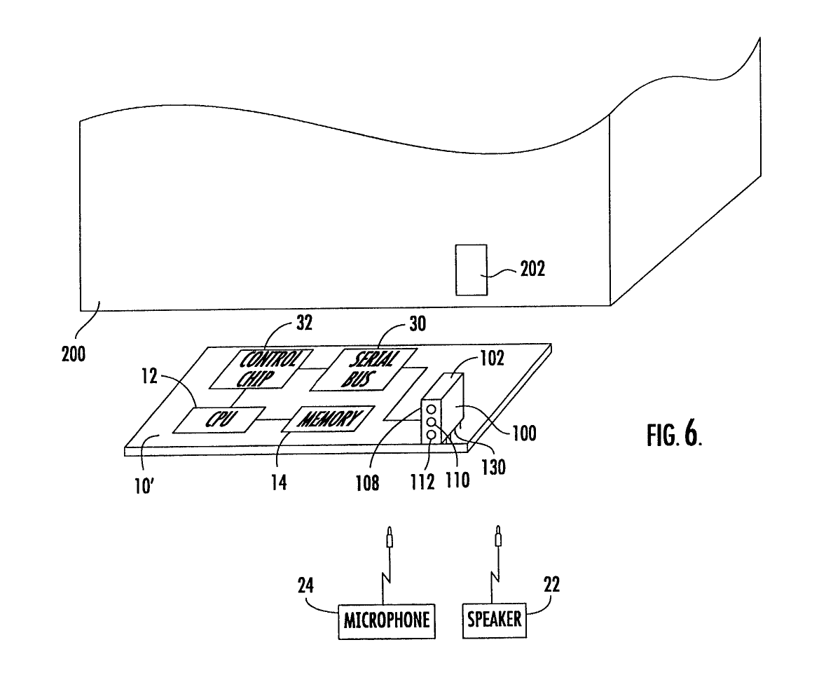

In this invention audio jack module 100, FIGS. 4-5 does include the audio interface functionality previously associated with motherboard 100, FIG. 1 and yet, in the preferred embodiment, the size of audio jack module 100 is the same as prior art audio jack module 20, FIGS. 1-2 so it can be received in standard size computer enclosure input/output panel openings. Moreover, in the preferred embodiment, audio jack module 100, FIGS. 4-5 fully supports analog interface system connections (for a stereo CD-ROM, for example) and also supports components which operate at frequencies different than the frequency of the clock signal which operates the CODEC. One example is modems which operate at 12.288 MHz.

Integrated audio jack module 100, FIGS. 4-5, in one example, includes housing 102 of a predetermined size, typically the same size or sizes as prior art audio jack modules without integrated audio interface functionality and thus sized to be received in typical system enclosure input/output panel openings. Those skilled in the art know the various sizes of prior art audio jack modules and will configure housing 102 to meet the fit and form requirements of OEM system manufacturers.

Housing 102 may also include backplate 104. Analog interface plug assembly 106 is also included and typically is comprised of mechanical plug portions 108, 110, and 112 and electrical contact portion 116 including a number of conductors 118 electrically and physically connected to circuit board 120.

Circuit board 120 includes an audio coder/decoder circuit and also audio support circuitry discussed infra. Digital interface system leads 130 extend from housing 102 as shown in FIG. 5. Circuit board 120 plugs into header 132 housed in housing bottom element 134 and is electrically connected to digital interface system leads 130.

In this way, the CODEC circuit and the audio support circuit populating circuit board 120 is interconnected between analog interface plug assembly 106 and digital interface system leads 130 (and other leads) resulting in a segregated, shielded, low noise audio interface for processor based systems and equipment of many different types and configurations.

Preferably, all of the components of housing 102 are typically made of metal to shield the CODEC circuit and the audio support circuit on circuit board 120 resulting in a prequalified audio interface in terms of electromagnetic interference and electrostatic discharge and noise. Analog interface plug assembly 106 may include RCA, mini-RCA, 3.5 mm and/or 2.5 mm plugs, any other standard plugs, and even plugs of custom designs.

Digital interface system leads 130 may be conductive pins as shown which electrically and physically connect jack module 100 to the motherboard of a typical system. In other examples, the digital interface system leads may be surface mount conductors.

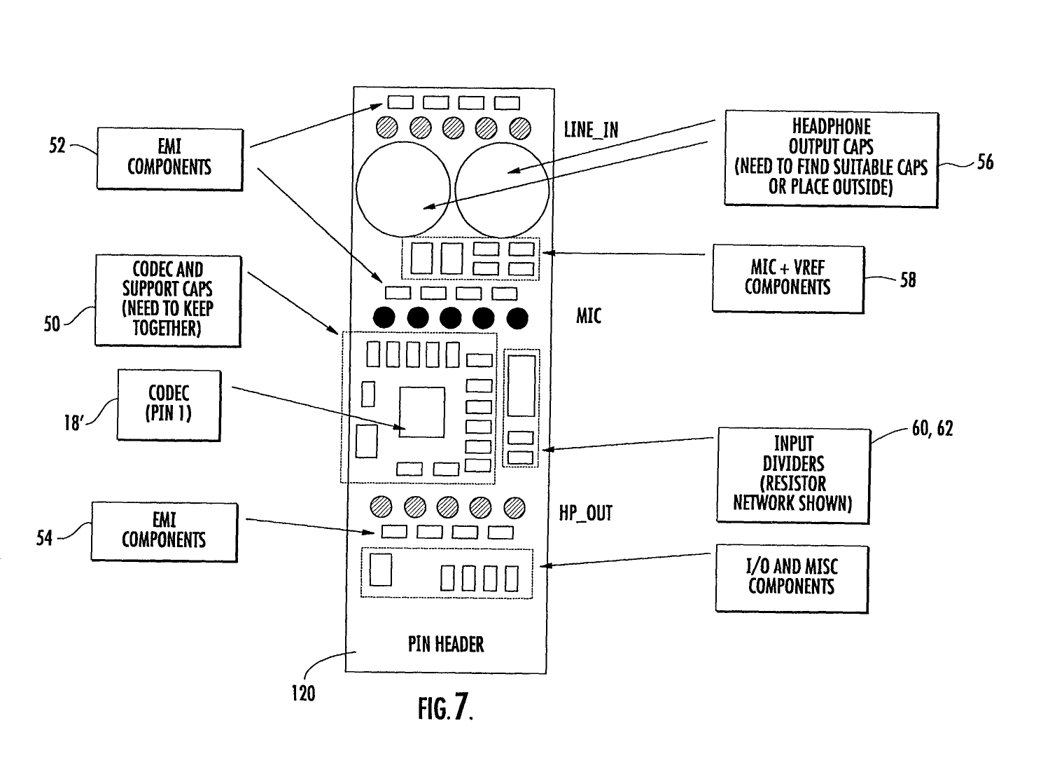

A complete system with the audio jack 100, FIG. 6 of this invention in place thus would include system enclosure 200 with input/output panel opening 202. As delineated above, one feature of integrated audio jack module 100 is that it is sized to be received in input/output panel openings of standard sizes so that no reconfiguration is required of standard systems enclosures or input/output panels. Inside enclosure 202 is motherboard 10′ which now does not include a CODEC or audio support circuitry since that functionality is now integrated in audio jack module 100. Accordingly, there is now more room on motherboard 10′ for other circuitry to thus provide additional functionality Speaker 22 and microphone 24 may be plugged into mechanical plug portions 108, 110, or 112 of audio jack module 100 and the circuitry therein functions to convert the analog output of microphone 24 to a digital signal output to motherboard 10′ by one digital interface system lead 130 which is ultimately processed by CPU 12 after being communicated thereto by serial bus 30 and control chip 32. Digital signals are correspondingly received by one digital interface system lead 130 of jack module 100 from motherboard 10′ and converted to an analog signal by the circuitry of jack module 100 and then output to speaker 22 by one plug 108, 110 or 112.

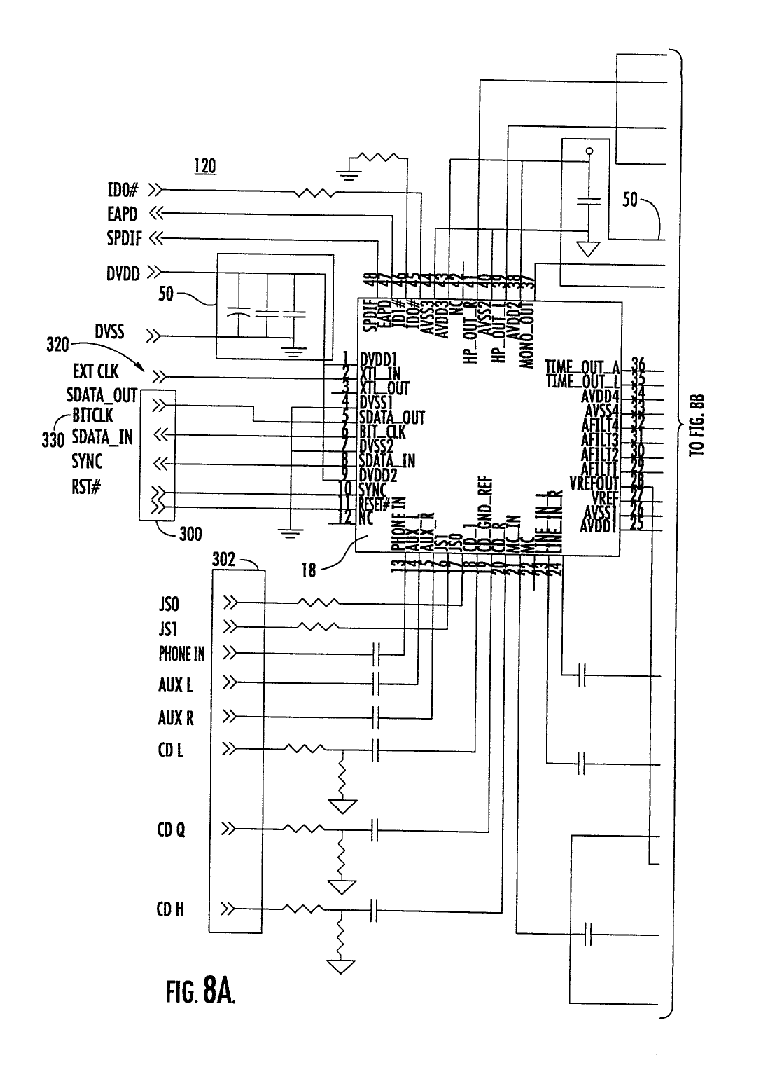

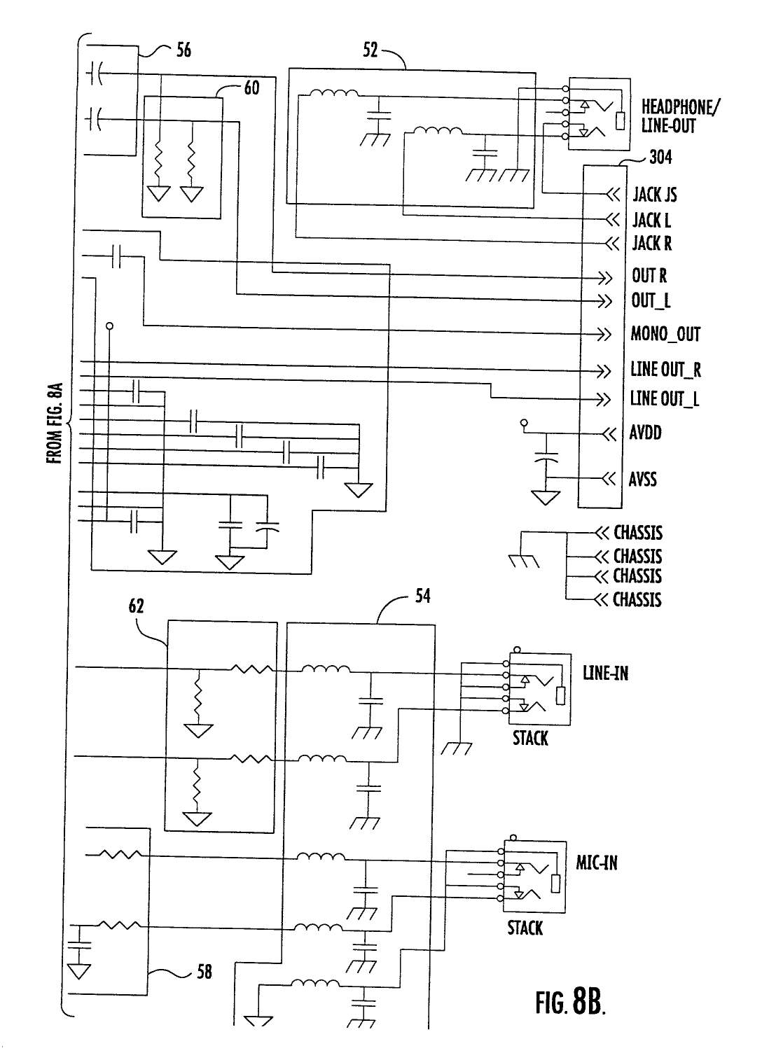

The primary exemplary functionality associated with circuit board 120, FIGS. 4-5 inside the audio jack module of this invention includes a die similar in many respects to the die of the prior art AD 1981 chip functioning as CODEC 18′, FIG. 7. Circuit board 120, FIGS. 4-5 also includes audio support circuitry in the form of CODEC specific support sub-circuit 50, FIG. 7, EMI subcircuits 52 and 54, headphone sub-circuit 56, microphone sub-circuit 58, input sub-circuit 60 and 62, and the other topology shown in FIGS. 7-8.

Additional details concerning one example of such audio support circuitry is shown in FIG. 8. A comparison of the circuitry of the circuit board of the audio jack module of this invention as shown in FIG. 8 and the audio circuitry of the prior art system motherboard shown in FIG. 3 reveals similarites which thus need not be explained further.

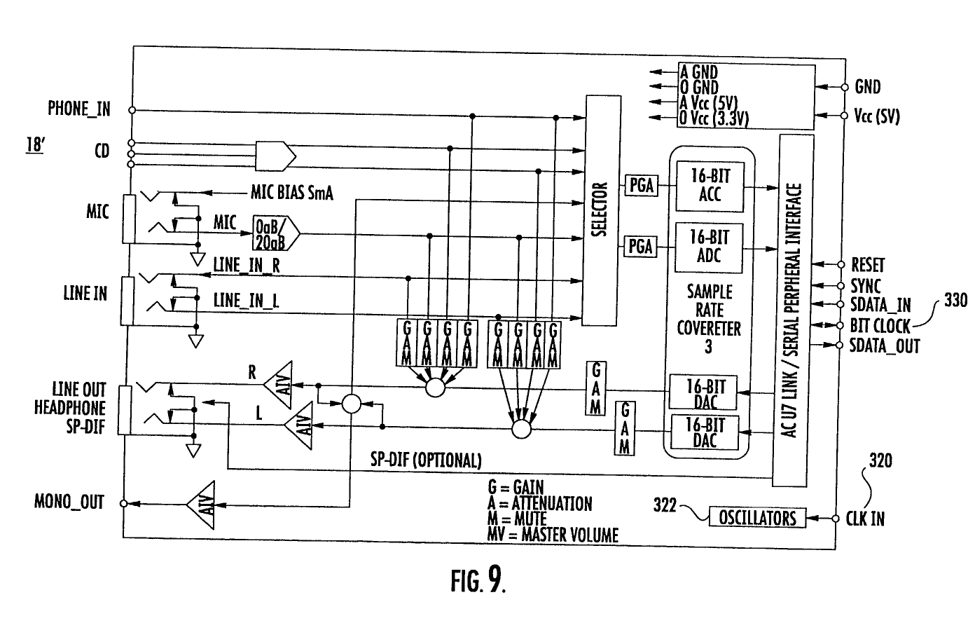

In this invention, there may be 33 total system interface leads 130, FIGS. 4-5 extending from the integrated audio jack module of this invention to be electrically connected to a motherboard of a system, five of which as shown at 300 in FIG. 8 are the digital interface system leads. In this example, the five digital interface system leads are BITCLOCK, SYNC, SDATA_OUT, SDATA_IN, and RESET. The leads in groups 302 and 304 are analog system leads interconnected with CODEC die 18 through the audio support circuitry to support system internal analog connections. Thus, CODEC 18′, FIG. 9 includes analog mixer 310, connected to the analog system leads, the digital interface connected to the digital system leads and analog to the digital converters and digital to analog converter 312 interconnected between the analog interface system leads and the digital interface system leads.

This mixer feature ensures the functionality of prior art analog interface system interconnections (for a CD-ROM input, for example) is not lost when the jack module of this invention is integrated to include the CODEC die and audio support circuit functionality.

Further included on circuit board 120, FIG. 8 of the integrated audio jack module of this invention is clock input 320. CODEC 18′, FIG. 9 includes phase lock loop circuit 322 connected to clock input 320 to convert the clock signal thereon to a different frequency. In the preferred embodiment, the clock signal on clock input 320, FIG. 8, is 14.31818 MHz (the frequency used to drive CODEC 18′) and phase lock loop circuit 322 converts this signal to a 12.288 MHz signal provided to clock output 330 pin (BITCLOCK) to support circuitry and components (e.g., modems) which run at a frequency of 12.288 MHz.

Thus, the integration of the CODEC and the audio support circuit functionality of this invention in a unique audio jack module supports system circuitry and components which operate at a frequency other than that which drives CODEC 18′, FIGS. 8-9 and without the need for the large clock oscillator circuit 90, FIG. 3 of the prior art.

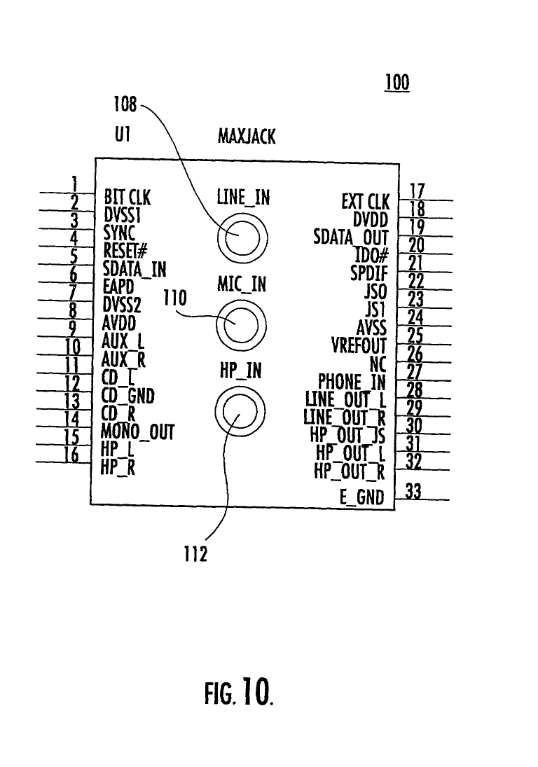

FIG. 10 exemplifies the simplicity of how a motherboard designer and/or system designer incorporates the integrated audio jack module of this invention into a processor based system: the 33 interface system pin leads are labeled as are the three analog plug assemblies. The system or motherboard designer is thus able to easily incorporate the prequalified standard size audio jack module 100 of this invention knowing, from FIG. 10, that it supports internal system analog connections and 12.288 MHz clock frequencies. The system designer is then able to use the additional motherboard space previously taken up by the audio CODEC chip and the related audio support circuitry to add additional functionality to the system. Design flexibility is increased and the design engineer is no longer concerned with noise or interference problems associated with the audio circuitry since all of that circuitry is integrated into the prequalified integrated audio jack module of this invention which a priori is tested to ensure compliance with electromagnetic interference and electrostatic discharge standards and requirements.

As used herein, an analog-to-digital (A-D) converter (ADC) is a device that converts an analog signal to a digital signal that represents equivalent information; a digital-to-analog (D-A) converter (DAC) is a device that converts a digital input signal to an analog output signal carrying equivalent information; an analog mixer is a nonlinear circuit or device that accepts as its input two different frequencies and presents at its output (a) a signal equal in frequency to the sum of the frequencies of the input signals, (b) a signal equal in frequency to the difference between the frequencies of the input signals, and, if they are not filtered out, (c) the original input frequencies; and a phase-locked loop (PLL) is an electronic circuit with a voltage or current-driven oscillator that is constantly adjusted to match in phase (and thus lock on) the frequency of an input signal. A PLL can be used to generate a signal, modulate or demodulate a signal, reconstitutes a signal with less noise, or multiply or divide a frequency.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims.

What is claimed is:

1. An audio jack module with integrated audio interface functionality comprising:
a housing of a predetermined size;
at least one analog interface plug assembly on the housing;
a number of digital interface system leads extending from the housing; and
a circuit board in the housing including an audio coder/decoder circuit and audio support circuitry interconnected between the analog interface plug assembly and the digital interface system leads resulting in a segregated, shielded, low noise audio interface.

2. The audio jack module of claim 1 in which the housing is made of metal to shield the coder/decoder circuit and the audio support circuitry.

3. The audio jack module of claim 1 in which the analog interface plug assembly includes a mechanical plug portion and an electrical contact portion including a number of conductors electrically connected to the circuit board.

4. The audio jack module of claim 1 in which there are a plurality of audio interface plug assemblies.

5. The audio jack module of claim 1 in which the analog interface plug assembly is selected from the group consisting of RCA, mini-RCA, 3.5 mm, and 2.5 mm plugs.

6. The audio jack module of claim 1 further including a header inside the housing which comprises the digital interface system leads and which receives the circuit board to electrically connect it to the digital interface system leads.

7. The audio jack module of claim 1 in which the predetermined size of the housing is the same as an audio jack module without integrated audio interface functionality.

8. The audio jack module of claim 1 in which the predetermined size of the housing is sized to be received in a standard system enclosure input/output panel opening.

9. The audio jack module of claim 1 in which the digital interface system leads are pins.

10. The audio jack module of claim 1 further including analog interface system leads interconnected with the coder/decoder circuit to support internal system analog connections.

11. The audio jack module of claim 10 in which the coder/decoder circuit includes an analog mixer connected to the analog interface system leads, the digital interface system leads, and the analog interface plug assembly.

12. The audio jack module of claim 10 in which the coder/decoder includes an analog-to-digital converter interconnected between the analog interface system leads and the digital interface system leads.

13. The audio jack module of claim 1 further including a clock input and the audio coder/decoder includes a phase lock loop circuit connected to the clock input to convert a clock signal thereon to a different frequency.

14. The audio jack module of claim 13 in which the phase lock loop is configured to convert the clock signal from a 14.31818 MHz signal to a 12.288 MHz signal.

15. The audio jack module of claim 13 further including a clock output for transmitting the different frequency clock signal.

16. A processing/audio interface system comprising:
a motherboard with processing functionality; and
a segregated audio jack module electrically connected to the motherboard, the jack module including:
a housing of a predetermined size,
at least one analog interface plug assembly on the housing,
a number of digital interface system leads extending from the housing and electrically connected to the motherboard, and
a circuit board in the housing including an audio coder/decoder circuit and audio support circuitry interconnected between the analog interface plug assembly and the digital interface system leads.

17. The audio jack module of claim 16 in which the housing is made of metal to shield the coder/decoder circuit and the audio support circuitry.

18. The audio jack module of claim 16 in which the analog interface plug assembly includes a mechanical plug portion and an electrical contact portion including a number of conductors electrically connected to the circuit board.

19. The audio jack module of claim 16 in which there are a plurality of audio interface plug assemblies.

20. The audio jack module of claim 16 in which the analog interface plug assembly is selected from the group consisting of RCA, mini-RCA, 3.5 mm, and 2.5 mm plugs.

21. The audio jack module of claim 16 further including a header inside the housing which comprises the digital interface system leads and which receives the circuit board therein.

22. The audio jack module of claim 16 in which the predetermined size of the housing is the same as an audio jack module without integrated audio interface functionality.

23. The audio jack module of claim 16 in which the predetermined size of the housing is sized to be received in a standard system enclosure input/output panel opening.

24. The audio jack module of claim 16 in which the digital interface system leads are pins.

25. The audio jack module of claim 16 further including analog interface system leads interconnected with the coder/decoder circuit to support internal system analog connections.

26. The audio jack module of claim 25 in which the coder/decoder circuit includes an analog mixer connected to the analog interface system leads, the digital interface system leads, and the analog interface plug assembly.

27. The audio jack module of claim 25 in which the coder/decoder includes an analog-to-digital converter interconnected between the analog interface system leads and the digital interface system leads.

28. The audio jack module of claim 16 further including a clock input and the audio coder/decoder includes a phase lock loop circuit connected to the clock input to convert a clock signal thereon to a different frequency.

29. The audio jack module of claim 28 in which the phase lock loop is configured to convert the clock signal from a 14.31818 MHz signal to a 12.288 MHz signal.

30. The audio jack module of claim 28 further including a clock output for transmitting the different frequency clock signal.

31. An audio jack module with integrated audio interface functionality comprising:
a housing;
a plurality of analog interface conductors on the housing;
a number of digital interface system conductors exterior of the housing; and
a circuit board in the housing including an audio coder/decoder circuit and audio support circuitry interconnected between the analog interface conductors and the digital interface system conductors resulting in a segregated, shielded, low noise audio interface.

32. The audio jack module of claim 31 in which the housing has a predetermined size the same as standard audio jack modules without integrated audio interface functionality and sized to be received in standard system enclosure input/output panel openings.

33. An audio jack module with integrated audio interface functionality comprising:
a housing;
at least one analog interface plug assembly on the housing;
a number of digital interface system leads extending from the housing;
a circuit board in the housing including an audio coder/decoder circuit and audio support circuitry interconnected between the analog interface plug assembly and the digital interface system leads; and
analog interface system leads interconnected with the coder/decoder circuit to support internal system analog connections.

34. The audio jack module of claim 33 in which the coder/decoder circuit includes an analog mixer connected to the analog interface system leads, the digital interface system leads, and the analog interface plug assembly.

35. The audio jack module of claim 34 in which the coder/decoder circuit further includes an analog to digital converter interconnected between the analog interface system leads and the digital interface system leads.

36. An audio jack module with integrated audio interface functionality comprising:
a housing;
at least one analog interface plug assembly on the housing;
a number of digital interface system leads extending from the housing;
a clock input; and
a circuit board in the housing including an audio coder/decoder circuit and audio support circuitry interconnected between the analog interface plug assembly and the digital interface system leads, the coder/decoder including a phase lock loop circuit connected to the clock input to convert a clock signal thereon to a different frequency.

37. The audio jack module of claim 36 in which the phase lock loop is configured to convert the clock signal from a 14.31818 MHz signal to a 12.288 MHz signal.

38. The audio jack module of claim 36 further including a clock output lead for transmitting the different frequency clock signal.

39. An audio jack module with integrated audio interface functionality comprising:
a housing of a predetermined size;
at least one analog interface plug assembly on the housing;
a number of digital interface system leads extending from the housing; and
means for converting analog signals received by the analog interface plug assembly to digital signals output by the digital interface system leads and for converting digital signals received by the digital interface system leads to analog signals output by the analog interface plug assembly.

40. The audio jack module of claim 39 in which the means for converting includes an audio coder/decoder circuit and audio support circuitry interconnected between the analog interface plug assembly and the digital interface system leads.
